(19) United States
(12) Patent Application Publication
(10) Pub. No.: US 2010/0000609 A1
(43) Pub. Date: Jan. 7, 2010

(54) FLUID MIXTURES

(76) Inventor: Brian Arthur Goody, Surrey (GB)

Correspondence Address: Intellectual Property Dept.;Dewitt Ross & Stevens SC, 2 East Mifflin Street, Suite 600, Madison, WI, 53703-2865, US

(21) Appl. No.: 12/525,896

(22) PCT Filed: Dec. 19, 2007
(86) PCT No.: PCT/GB2007/004894

§ 371 Date: Aug. 5, 2009

(30) Foreign Application Priority Data
Feb. 6, 2007 (GB) 0702273.4

(51) Int. Cl. G05D 11/02

(52) U.S. Cl. 137/7; 137/88; 137/98

(57) ABSTRACT

A gas mixing device feeds from two gas sources (1, 4), placing each gas into half of a chamber (17, 16) which is divided by a flexible physical barrier (12), such that pressure is equalised across the chambers (16, 17). Upon the release of each gas from each chamber at the same time into a mixing barrel (7), exit pressures and thus mixing characteristics are suitably controlled for a desired mix of gasses, due to the pressure balancing effect of the flexible barrier (12). The device might also be termed a divider or a dilutor. The device might be used in the mixing of low concentrations of carbon monoxide, such as 1 percent, in nitrogen with more nitrogen to dilute the concentration to 0.001 percent.

The present invention relates to the production of fluid mixtures, and in particular to gas mixtures having different concentrations of an analyte gas.

Standard gas mixtures are available in gas cylinders. A cylinder will contain a fixed concentration of an analyte gas (e.g. carbon monoxide) in a matrix gas (e.g. nitrogen). The analyte concentration in a cylinder will be determined during manufacture of the mixture, after which it is not adjustable. The mixture may be certified as a standard of fixed concentration.

Low concentration gas mixtures stored under pressure in cylinders may not be stable due to interaction with the internal surface of the cylinder. Low concentrations are often generated by dilution of a higher concentration mixture that is more stable when stored in a pressurised cylinder.

A flow of analyte gas may be combined with a flow of matrix gas to provide an appropriate dilution. Adjustment of the two flow rates provides a means of adjusting the concentration of analyte in the combined flow. Various devices, using a variety of techniques exist to perform this function and are usually known as “gas flow dilutors” or “gas dividers”. The combination of an analyte gas mixture, a matrix gas, a gas flow dilutor and components to connect them together is currently used to provide different gas concentrations.

DE 100 60 326 discloses a device that regulates the mixing of carbon dioxide and nitrogen by movement of a porous piston in a cylinder. Whilst the device allows adjustment of the concentration of the mixture, the precise mixing ratio is not calibrated. Moreover, the device is unsuitable for dilution ratios greater than 100:1. This is because the piston would need to be close to one end of its position range making fine adjustment unrealistic.

FR 2 532 858 discloses apparatus that uses mass flow measurement and control to determine the flow of one gas and thereby to adjust automatically the flows of other gases in the proportions needed to give the required concentration mixture. The apparatus is complex, incorporating electromechanical and electronic components. Moreover, this apparatus is unsuitable for producing gas mixtures of sufficiently accurate concentration to be used as calibration standards.

U.S. Pat. No. 5,544,674 discloses a gas mixing valve including first and second control valves for controlling the flow of two gases to be mixed. The control valves are intended to compensate for changes in flow rate without changing the mixing ratio. However, this depends on the shape of the flow controlling surfaces of the valves and on the shape and relative position of two cams that are used to adjust the valve openings. This device is thus mechanically complex, and yet whilst some degree of calibration is possible, it is not sufficiently accurate for use as a calibration standard.

US 2005/0115987 discloses one gas cylinder within another with independent means for controlling the gas flow from each cylinder. The total output flow is not readily adjusted without the concentration of the gas mixture being affected. Although pressure regulators with pressure gauges and orifices are used to control the flow, the control is not precise enough to be used as an accurate calibration standard.

Existing gas flow dilutors are complex. Many rely on pre-set adjustment of cams or other mechanical, electromechanical or electronic components to render the output concentration independent of total output flow. In existing dilutors, where the flows of two gases need to be independently adjusted, this can lead to inaccuracies in the final concentration of the gas mixture.

The present invention seeks to provide improved production of fluid mixtures.

According to a first aspect of the present invention there is provided apparatus as specified in claim 1.

Providing the first fluid and the second fluid at substantially equal pressure to the flow controllers means that the flow rates of the first fluid and the second fluid through the flow controllers remain at the same ratio irrespective of the absolute flow values. Since the pressure of the first fluid is adjusted by means of the pressure of the second fluid, changing the pressure of the second fluid automatically changes the pressure of the first fluid. The overall flow rate can thus be adjusted by adjusting only the pressure (and hence flow rate) of the second fluid, and without any significant change in ratio of the first fluid and the second fluid output by the flow controllers.

In the preferred embodiment, the pressure equalisation means includes the holding chamber being a variable volume vessel the variable volume vessel being arranged such that its volume is able to change as a result of the pressure of the second fluid. The variable volume vessel provides a convenient means for the pressure of the second fluid to influence the pressure of the first fluid directly. In some cases the volume of the variable volume vessel is determined by the amount of the first fluid.

Preferably, the variable volume vessel includes a flexible diaphragm responsive to the pressure of the second fluid, movement of the diaphragm resulting in a change in volume of the variable volume vessel. A flexible diaphragm can respond efficiently to any changes in pressure of the second fluid and translate these substantially immediately to the first fluid.

The first flow controller is preferably provided at an outlet of the holding chamber and the second flow controller is preferably provided at an outlet of a chamber for the second fluid.

The flow controllers are preferably critical orifices. Critical orifices are particularly advantageous because under the appropriate operating conditions the mass flow rate of gas through a critical orifice is proportional to the absolute pressure of that gas applied to its inlet and is independent of the pressure at its outlet.

Preferably a plurality of flow controllers is provided downstream of the outlet for the first fluid and/or downstream of the outlet for the second fluid. Selective activation of the flow controllers within the plurality enables different concentrations of the first fluid within the fluid mixture to be obtained.

The apparatus preferably includes temperature equalisation means for maintaining the temperature of the first fluid and the second fluid substantially equal. Temperature equalisation may be achieved by arranging the first flow, controller and the second flow controller so that they are in close thermal contact with each other and/or with, the first fluid and the second fluid. Providing the first fluid and the second fluid at substantially equal temperature to the flow controllers means that the flow rates of the first fluid and the second fluid remain at the same ratio irrespective of the absolute temperatures.

In the preferred, embodiment the holding chamber is provided with a closable inlet connectable to a source of the first fluid. This allows a predetermined amount of the first fluid to be stored in the apparatus, and for the holding chamber to be refilled with the first fluid.

The apparatus may include a mixing chamber within which the first fluid- and the second fluid are combined to form the mixture.

According to a second aspect of the present invention there is provided a method of producing a fluid mixture as specified in claim 11.

The method may include delivering the first fluid and the second fluid to a mixing chamber.

Preferably the holding chamber is a variable volume vessel and the pressures of the first fluid and the second fluid are equalised by using a second fluid at a selected pressure to reduce the volume of the variable volume vessel and thereby to increase the pressure of the first fluid to the selected pressure.

The selected pressure may be pre-set.

The method may include filling the holding chamber with the first fluid. This means that the apparatus can be re-used once the first fluid in the holding chamber has been used up.

In the preferred method, a flow of the first fluid into the variable volume vessel is stopped once the desired amount of the first fluid has been introduced, such that there is no further flow of the first fluid into the variable volume vessel during pressure equalisation. This allows a predetermined amount of the first fluid to be stored in the apparatus. Moreover, a constant flow of the first fluid is not required.

Preferably, a plurality of flow controllers is provided for the first fluid and the method includes selecting which flow controller or flow controllers of the plurality are activated, thereby enabling alteration of the concentration of the fluid mixture obtained.

In an embodiment, a plurality of flow controllers is provided for the second fluid and the method includes selecting which flow controller or flow controllers of the plurality are activated thereby enabling alteration of the total flow rate and concentration of the fluid mixture obtained. This allows an additional means of adjusting the output concentration and would also provide a means of adjusting the total flow. The two adjustments may be interdependent.

The first fluid and the second fluid are preferably supplied to the first flow controller and the second flow controller at substantially equal temperature. This means that the flow rates of the first fluid and the second fluid remain at the same ratio irrespective of the absolute temperatures. The temperatures of the flow controllers are also preferably equal to the first and second fluid temperatures.

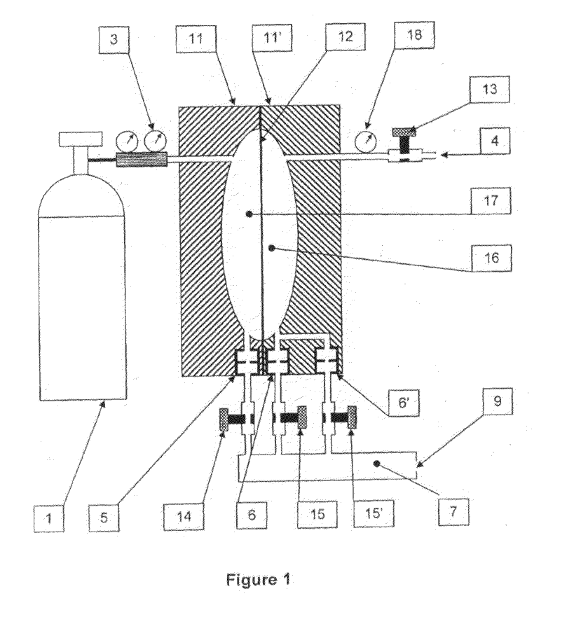

Preferred embodiments of the present invention are described below, by way of example only and with reference to the accompanying drawing, in which FIG. 1 shows a schematic representation of a preferred embodiment of the invention.

A controlled amount of pure or diluted analyte gas (for example, a 1% mixture of carbon monoxide in nitrogen), having a standard concentration is introduced from an external source into an analyte gas chamber 16 via an inlet 4 and a tap 13. The tap 13 is subsequently closed, and the pressure of the analyte gas within the analyte gas chamber 16 is indicated by a pressure gauge 18. The analyte gas chamber 16 is formed between a block 11′ (shown in section) and a flexible diaphragm 12 that is sealed to the block around its perimeter.

An outlet (or outlets) from the analyte gas chamber 16 enables analyte gas to be delivered to critical orifices 6,6′. A critical orifice is an orifice through which gas flows at the speed of sound. This happens when the pressure of gas at the inlet is at least double the pressure of gas at the outlet. Critical orifices are also known as “sonic nozzles” or “sonic Venturi nozzles”. The mass flow rate from a critical orifice is a function of the size of the orifice and upstream absolute pressure and temperature.

A cylinder 1 of matrix gas (for example, nitrogen) is connected to a pressure regulator 3 for supplying the matrix gas at a controlled but adjustable pressure into a matrix gas chamber 17. The matrix gas chamber 17 is formed between a block 11 (shown in section) and the flexible diaphragm 12 that is sealed to the block around its perimeter. An outlet from the matrix gas chamber 17 enables matrix gas to be delivered to a critical orifice 5.

The critical orifices 5, 6, 6′ are sealed into close fitting bores in the blocks 11, 11′ so as to achieve good thermal contact therewith and to maintain the critical orifices 5, 6, 6′ and the analyte gas and the matrix gas at substantially equal temperature. The blocks 11, 11′ are preferably metal.

It can thus be seen that in the preferred embodiment the blocks 11, 11′ together enclose a volume that is divided by the flexible diaphragm 12. The flexible diaphragm 12 separates the analyte gas chamber 16 from the matrix gas chamber 17, and enables the volume of each to be varied.

Critical orifices 5,6,6′ provide controlled flows of gas proportional to the pressure of the gas at their input. This flow is independent of output pressure (provided the output-pressure is less than approximately half the input pressure). Taps 14,15,15′ are provided downstream of the critical orifices 5,6,6′. These can be opened to allow the critical orifices 5,6,6′ to provide controlled gas flows into a mixing chamber 7. In this embodiment, the mixing chamber 7 has three inlets and a single outlet 9 for the gas mixture produced.

The apparatus is constructed with materials appropriate to the gas species to be used.

In order to prepare the device for use the analyte gas chamber 16 is first charged with a controlled amount of analyte gas through the tap 13. Prior to charging the device with analyte gas, any residual gas contained in the analyte gas chamber 16 and its associated pipework is removed by evacuation-using an external pump (not shown). This is to minimise contamination of the charge of analyte gas by gas that may previously have been held within the analyte gas chamber 16. This procedure could be omitted in some circumstances, for example where the analyte gas chamber 16 is to be re-filled with the same analyte gas. Once the analyte gas chamber 16 has been charged, the tap 13 is closed.

The flow rate of matrix gas is set by adjustment of the pressure regulator 3 (for example, 5 bar pressure to produce 1 normal litre/minute flow). This determines the pressure of the matrix gas applied to the matrix gas chamber 17. The pressure of the matrix gas should be set within the range of values that allows the diaphragm 12 to be free to move between the internal wall of the blocks 11, 11′, as will be appreciated by the skilled person. The taps 14,15,15′ are turned on and the diaphragm position automatically adjusts so that the pressure of the analyte gas in the analyte gas chamber 16 equalises to the pressure of the matrix gas in the matrix gas chamber 17.

The diaphragm 12 is very flexible and is preferably impervious to gas. It may be fabricated from thin metal foil such as stainless steel, and be preformed to fit closely the shape of the internal surfaces of the blocks 1, 11′. It preferably moves by flexing and bending rather than by stretching. All of the critical orifices 5,6,6′ are therefore subject to substantially the same gas input pressures, equal to the output pressure of the pressure regulator 3. The critical orifices 5, 6, 6′ are also at substantially the same temperature.

The flow of analyte gas that is added to the matrix gas (and thus the concentration of the gas mixture) can be changed by selectively closing the taps 15, 15′.

For example, when operated at a typical matrix gas pressure of 5 bar, the flow of matrix gas through the critical orifice 5 and into the mixing chamber 7 would be 1 normal litre per minute. When the tap 15 is opened, the critical orifice 6 adds a flow of 1 normal millilitre per minute of analyte gas into the mixing chamber 7. When the tap 15′ is opened, the critical orifice 6′ adds a flow of 2 normal millilitres per minute of analyte gas into the mixing chamber 7. If both of the taps 15, 15′ were opened, the combined flow of analyte gas added to the mixing chamber 7 would be 3 normal millilitres per minute.

When the analyte gas chamber 16 is charged with an analyte gas of concentration 1000 units the concentrations given in Table 1 are generated.

TABLE 1

| TAP 5 | TAP 6 | TAP 6′ | ANALYTE | |
|---|---|---|---|---|
| CONDITION | CONDITION | CONDITION | CONCENTRATION | |
| open | closed | closed | 0 | units |
| open | open | closed | 1000/1001 | units |
| open | closed | open | 2000/1002 | units |
| open | open | open | 3000/1003 | units |

There are various advantages of the above-described arrangement.

The construction is simple, requires no adjustment during its build and no power source to operate it.

The analyte gas is contained within the device and a separate cylinder of analyte gas does not need to be permanently attached during operation. Prior art regulators require a minimum constant flow of analyte gas through them, increasing the gas consumption and requiring a permanently connected cylinder of analyte gas. In the present apparatus, in contrast, the analyte gas is held within the analyte gas chamber 16. This apparatus is particularly suited for large dilutions in which only a small amount of analyte gas is required.

Analyte gas is added in controlled, fixed proportions to an adjustable flow of matrix gas from an external source. This ratio is substantially independent of ambient temperature, matrix gas pressure and, within some limiting condition, outlet pressure.

The use of the flexible diaphragm 12 to allow variation in the volume of the matrix and analyte gas chambers 16,17 ensures that the pressures of the matrix gas and the analyte gas are substantially equal. If the pressures are equal then the flow rates of the matrix gas and the analyte gas through the critical orifices 5,6,6′ will remain practically at the same ratio irrespective of the absolute flow values. To increase the overall output flow rate, only the pressure and hence the flow rate of the matrix gas needs to be adjusted. The change in pressure of the matrix gas within the matrix gas chamber 17 will automatically result in a change in pressure of the analyte gas within the analyte gas chamber 16. In prior art systems, where the flow rates of the two gases are independently adjusted, subtle changes to the ratios of the flow rates can occur leading to inaccuracies in the final concentration of the gas mixture produced. Other prior art systems use differential pressure regulators to equalise the pressure of the analyte gas to that of the matrix gas. This type of regulator is relatively complex in its construction and does not achieve truly equal pressures as some difference in pressure is necessary for its operation.

Because the flexible diaphragm 12 moves by bending and flexing (rather than by stretching) practically no differential pressure between the surfaces of the diaphragm 12 is required to equalise the pressures.

The use of critical orifices 5,6,6′ is advantageous because the mass flow of gas is proportional to the upstream absolute pressure but independent of the downstream pressure. The concentration of gas produced can thus be dependent solely on the matrix gas pressure. The total flow of gas from the device can be varied by adjustment of the pressure of the matrix gas whilst automatically maintaining the same mixing ratio, as both the flow of matrix gas and the flow of analyte gas are proportional to the pressure of the matrix gas.

Whilst this apparatus may be more expensive when only one cylinder (i.e. one concentration of gas) is required it will become successively more cost-effective in applications that require many different concentrations. This is because the different concentration mixtures can be produced using only two gas sources, instead of requiring a separate gas source for each mixture having a different concentration.

A single apparatus can be used to create analyte gas mixtures that singly or in combination contain a plurality of gas species and concentrations.

If the apparatus is appropriately calibrated, other gas mixtures to which the analyte gas would then be added could replace the matrix gas.

The pressure gauge 18 indicates when the analyte gas chamber 16 has been charged with the correct amount of analyte gas (it will-display the pre-set pressure) and also when all of the analyte gas has been discharged (it will display zero).

This apparatus enables the production of gas mixtures with lower concentrations than could be stably stored in cylinders.

There are various modifications that can be made to the above-described embodiment.

A housing may be, provided to contain-some or all components. In an embodiment, all components except for the matrix gas cylinder 1 may be contained within such a housing. The housing may be a box that is conveniently attached to and supported by the matrix gas cylinder 1.

Capillaries could be used to control the gas flow instead of the critical orifices 5,6,6′. However, these are less preferred because flow is dependent on downstream pressure as well as upstream pressure. Other flow restrictors may also be used.

Non-critical orifices could also be used. These operate below the speed of sound.

Additional-critical orifices and taps can be provided downstream of the analyte gas chamber 16 to extend the range of adjustment of the concentration of the gas mixture. Preferably, in a series of critical orifices, each would provide twice the flow of a neighbouring critical orifice. By selecting which corresponding taps to open, a greater range of different concentrations of analyte gas may be obtained.

Additional critical orifices and taps could be provided downstream of the matrix gas chamber 17 to extend the range of adjustment of the concentration of the gas mixture and the range of total output flow.

Whilst the above-described flexible diaphragm 12 is the preferred means for varying the volume of the analyte gas chamber 17, other arrangements are possible.

In another method of charging the analyte gas chamber 16, that does not require a vacuum pump, tap 13 is opened to the atmosphere and a pressure of matrix gas is used to deflect the diaphragm 12 fully into the analyte gas chamber 16, thereby minimising its volume and expelling most of the previously contained gas. Following this, the taps 15,15′ are opened and analyte gas is connected to tap 13 and allowed to flow into the analyte gas chamber 16 from an external source. This establishes a flow of analyte gas through the critical orifices 6,6′ that is maintained for sufficient time to flush out the gas previously present in the analyte gas chamber 16. The analyte and matrix gas flows are then halted and the tap 14 is opened to allow the pressure in matrix gas chamber 17 to reduce to atmospheric. Taps 15, 15′ are then closed and analyte gas is flowed through tap 13 into chamber 16 until the desired pressure, indicated by gauge 18 is reached, whereupon tap 13 is closed and the analyte gas source disconnected from it. The device is then ready to be used.

In another embodiment a predetermined pressure and amount of the analyte gas may be contained in a cylinder attached to the inlet 4. In this case, the tap 13 could be omitted and replaced with a component to interface with such a cylinder. Prior to connection of the analyte gas cylinder a pressure of the matrix gas may be used to force the diaphragm 12 against the inner face of block 11′ to expel the majority of previously held gas.

Whilst the user may charge the analyte gas chamber 16 himself (thus allowing the possibility of refilling/reusing the apparatus), the apparatus could be supplied pre-charged with an analyte gas. Such a pre-charged version may or may not include an inlet to allow refilling/reuse by the user.

The matrix pressure regulator 3 could be separate from the apparatus.

The analyte gas source should preferably be of a standard concentration.

The above-described apparatus enables fluid mixtures having a range of different concentrations to be produced by adding a predetermined proportion of a first fluid to a second fluid as it flows thorough the apparatus. The concentrations of the fluid mixtures are accurately related to the concentration of the analyte gas and the properties of the flow controllers. With current techniques, a continuous flow of analyte gas from an external cylinder is required and inaccuracies in the final concentration are possible where independent adjustment of gas flows is necessary.

The disclosures in United Kingdom patent application No. GB 0702273.4, from which this application claims priority, and in the abstract accompanying this application are incorporated herein by reference.

1-21. (canceled)

22. A device for producing a mixture of a first fluid and a second fluid, the device including:
a. a holding chamber for the first fluid,
b. an inlet for the second fluid,
c. a first flow controller controlling a rate of flow of the first fluid from the holding chamber to a mixing chamber;
d. a second flow controller controlling a rate of flow of the second fluid from the inlet to the mixing chamber;
wherein the pressure of the first fluid within the holding chamber is dependent on the pressure of the second fluid within the device, such that the pressures of
(1) the first fluid within the holding chamber, and
(2) the second fluid within the device,
are at least substantially equal upon reaching the first and second flow controllers.

23. The device of claim 22 wherein the holding chamber has variable volume, with the volume being dependent on the pressure of the second fluid.

24. The device of claim 23 wherein the holding chamber includes a flexible diaphragm responsive to the pressure of the second fluid, the diaphragm being movable to change the volume of the holding chamber.

25. The device of claim 22 further including a movable wall situated between the holding chamber and the inlet, wherein motion of the wall alters the volume of the holding chamber.

26. The device of claim 25 wherein the movable wall is a flexible diaphragm.

27. The device of claim 22 wherein:
a. the first flow controller is provided at an outlet of the holding chamber, and
b. the second flow controller is provided at an outlet of a chamber for the second fluid, the chamber being in fluid communication with the inlet.

28. The device of claim 22 wherein at least one of the flow controllers is a critical orifice.

29. The device of claim 22 wherein two or more flow controllers are provided downstream of one or more of:
a. an outlet of the holding chamber, and
b. an outlet of a chamber for the second fluid, the chamber being in fluid communication with the inlet.

30. The device of claim 22 including a temperature equalizer maintaining the temperature of the first fluid and the second fluid substantially equal.

31. The device of claim 22 wherein the first flow controller and the second flow controller are situated in close thermal contact with each other.

32. The device of claim 22 wherein the holding chamber includes a closable inlet connectable to a source of the first fluid.

33. A method of producing a mixture of first and second fluids wherein:
i. the first fluid is within a holding chamber separated from a mixing chamber by a first flow controller, and
ii. the second fluid is separated from the mixing chamber by a second flow controller, the method including the steps of:
a. adjusting the pressure of the first fluid within the holding chamber in dependence on the pressure of the second fluid such that the pressures of the first fluid and the second fluid are at least substantially equalized,
b. providing:
(1) the first fluid to the first flow controller, and
(2) the second fluid to the second flow controller,
wherein the pressures of the first and second fluids are at least substantially equal, such that the ratio of the first fluid output by the first flow controller to the second fluid output by the second flow controller is substantially constant.

34. The method of claim 33 wherein:
a. the first fluid is output by the first flow controller to the mixing chamber, and
b. the second fluid is output by the second flow controller to the mixing chamber.

35. The method of claim 33 wherein:
a. the holding chamber is a variable volume vessel, and
b. the volume of the holding chamber is dependent on the pressure of the second fluid.

36. The method of claim 33 wherein the first fluid and the second fluid have at least substantially equal temperature when they are provided to the first flow controller and the second flow controller.

37. The method of claim 33 wherein the amount of the first fluid within the holding chamber is constant while the pressures of the first fluid and the second fluid are at least substantially equalized.

38. The method of claim 33 wherein several first flow controllers are included, each separating the holding chamber from the mixing chamber.

39. The method of claim 38 wherein several second flow controllers are included, each separating the inlet from the mixing chamber.

40. The method of claim 33 wherein the holding chamber is at least substantially evacuated of fluid prior to introducing the first fluid into the holding chamber.

41. The method of claim 40 wherein the holding chamber is at least substantially evacuated of fluid by reducing the volume of the holding chamber.

42. A device for producing a mixture of a first fluid and a second fluid, the device including:
a. an analyte gas chamber for the first fluid,
b. a matrix gas chamber for the second fluid,
c. a flexible diaphragm situated between the analyte gas chamber and the matrix gas chamber, wherein flexure of the diaphragm towards the analyte gas chamber:
(1) reduces the volume of the analyte chamber, and
(2) increases the volume of the matrix gas chamber;
d. a mixing chamber;
e. a first flow controlling valve separating the analyte gas chamber from the mixing chamber, and
f. a second flow controlling valve separating the matrix gas chamber from the mixing chamber.
